(19) United States
(12) Patent Application Publication
(10) Pub. No.: US 2012/0146416 A1
(43) Pub. Date: Jun. 14, 2012

(54) TEST APPARATUS

(75) Inventors: Masahiro Ishida, Tokyo (JP); Daisuke Watanabe, Tokyo (JP); Masayuki Kawabata, Tokyo (JP); Toshiyuki Okayasu, Tokyo (JP)

(73) Assignee: ADVANTEST CORPORATION, Tokyo (JP)

(21) Appl. No.: 13/311,356

(22) Filed: Dec. 5, 2011

(30) Foreign Application Priority Data
Dec. 8, 2010 (JP) 2010-274018

(51) Int. Cl. H02J 1/10

(52) U.S. Cl. 307/44

(57) ABSTRACT

A DUT comprises a notifying circuit configured to generate a notification signal which is used to notify an external circuit of an event that leads to a change in the operating current of the DUT before such an event occurs. A main power supply supplies electric power to a power supply terminal of the DUT. A power supply compensation circuit comprises a switch element which is controlled according to a control signal, and is configured to generate a compensation pulse current according to the on/off state of the switch element. A compensation control circuit receives the notification signal from the DUT, and outputs, to the power supply compensation circuit, a control signal which is used to control the switch element, and which is generated based upon at least the notification signal.

### BACKGROUND OF THE INVENTION

1. Field of the Invention

The present invention relates to a technique for stabilizing a power supply.

2. Description of the Related Art

In a testing operation for a semiconductor integrated circuit that employs CMOS (Complementary Metal Oxide Semiconductor) technology (which will be referred to as the “DUT” hereafter) such as a CPU (Central Processing Unit), DSP (Digital Signal Processor), memory, or the like, electric current flows in a flip-flop or a latch included in the DUT while it operates receiving the supply of a clock. When the clock is stopped, the circuit enters a static state in which the amount of current decreases. Accordingly, the sum total of the operating current (load current) of the DUT changes over time depending on the content of the test operation, and so forth.

A power supply circuit configured to supply electric power to such a DUT has a configuration employing a regulator, for example. Ideally, such a power supply circuit is capable of supplying constant electric power regardless of the load current. However, in actuality, such a power supply circuit has an output impedance that is not negligible. Furthermore, between the power supply circuit and the DUT, there is an impedance component that is not negligible. Accordingly, the power supply voltage fluctuates due to fluctuation in the load.

Fluctuation in the power supply voltage seriously affects the test margin for the DUT. Furthermore, such fluctuation in the power supply voltage affects the operations of other circuit blocks included in the test apparatus, such as a pattern generator configured to generate a pattern to be supplied to the DUT, a timing generator configured to control the pattern transition timing, etc., leading to deterioration in the test accuracy.

With such a technique described in Patent document 2, such an arrangement includes a compensation circuit including a switch configured to switch on an off according to the output of a driver, in addition to a main power supply configured to supply a power supply voltage to a device under test. With such an arrangement, a compensation control pattern to be applied to a switch element is defined according to the test pattern so as to cancel out fluctuation in the power supply voltage that would occur according to the test pattern to be supplied to the device under test. In an actual test operation, such an arrangement supplies a test pattern to such a device under test while switching the switch included in the compensation circuit according to the control pattern, thereby maintaining the power supply voltage at a constant level.

### RELATED ART DOCUMENTS

### Patent Documents

### Patent Document 1]

Japanese Patent Application Laid Open No. 2007-205813

### Patent Document 2

International Publication WO 10/029709A1 pamphlet

Such a technique described in Patent document 2 requires that the operating current of the DUT is predictable based upon the test pattern. However, a highly functional IC (Integrated Circuit) such as an SoC (System On Chip) or the like has the potential to have an operating state that fluctuates independent of the test pattern.

### SUMMARY OF THE INVENTION

The present invention has been made in view of such a situation. Accordingly, it is an exemplary purpose of the present invention to provide a technique for stabilizing the power supply voltage when testing a device under test that has the potential to have an operating state that fluctuates independent of the test pattern.

An embodiment of the present invention relates to a test apparatus configured to test a device under test. The device under test comprises a notifying circuit configured to generate a notification signal that is used to notify an external circuit of an event, which leads to a change in an operating current of the device under test, before the event occurs. The test apparatus comprises a main power supply configured to supply electric power to a power supply terminal of the device under test, a power supply compensation circuit, and a compensation control circuit. The power supply compensation circuit comprises at least one of a source compensation circuit and a sink compensation circuit. The source compensation circuit comprises a switch element controlled according to a control signal, and is configured to generate a compensation pulse current according to an on/off state of the switch element, and to inject the compensation pulse current to the power supply terminal via a path that differs from that of the main power supply. The sink compensation circuit comprises a switch element controlled according to a control signal, and is configured to generate a compensation pulse current according to an on/off state of the switch element, and to draw, via a path that differs from that of the device under test, the compensation pulse current from a power supply current that flows from the main power supply to the device under test. The compensation control circuit is configured to receive the notification signal that indicates the operation state of the device under test from the device under test, and to output, to the switch element, the control signal which is used to control the switch element, and which is generated based upon at least the notification signal.

With such an embodiment, the waveform of the operating current of the device under test is predicted based upon the notification signal, and the power supply compensation circuit is instructed to generate a compensation current that corresponds to the waveform of the operating current thus predicted. Thus, such an arrangement is capable of suppressing fluctuation in the power supply voltage, or of providing an intentional change in the power supply voltage, even if the device under test performs an autonomous operation that is independent of the test pattern.

Also, the device under test may comprise multiple cores. Also, an event in which the number of active cores is switched may be used as the aforementioned event.

Also, the device under test may be configured to be capable of changing its operating frequency. Also, an event in which the operating frequency of the device under test is switched may be used as the aforementioned event.

Also, the device under test may comprise a clock gating circuit. Also, an event in which an on/off operation of the clock gating circuit is switched may be used as the aforementioned event.

Also, the device under test may comprise a power gating circuit. Also, an event in which an on/off operation of the power gating circuit is switched may be used as the aforementioned event.

Also, the device under test may be configured as an SoC (System On Chip) comprising an analog circuit device or an analog circuit. Also, an event in which an operation mode of the analog circuit is switched may be used as the aforementioned event.

Also, the device under test may be configured as an SoC (System On Chip) comprising an analog circuit device or an analog circuit. Also, an event in which settings of the analog circuit are switched may be used as the aforementioned event.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a test apparatus according to an embodiment;

FIG. 2 is a flowchart which shows an example of a method for calculating a control pattern;

FIG. 3 is a waveform diagram showing an example of an operating current I_{OP}, a power supply current I_{DD}, a source compensation current I_{CMP}, and a source pulse current I_{SRC};

FIGS. 4A and 4B are circuit diagrams each showing an example configuration of a power supply compensation circuit;

FIG. 5A through 5C are circuit diagrams each showing another example configuration of a power supply compensation circuit;

FIG. 6 is a block diagram which shows a configuration of a test apparatus according to an embodiment; and

FIG. 7 is a time chart which shows the operation of the test apparatus shown in FIG. 6.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B. Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

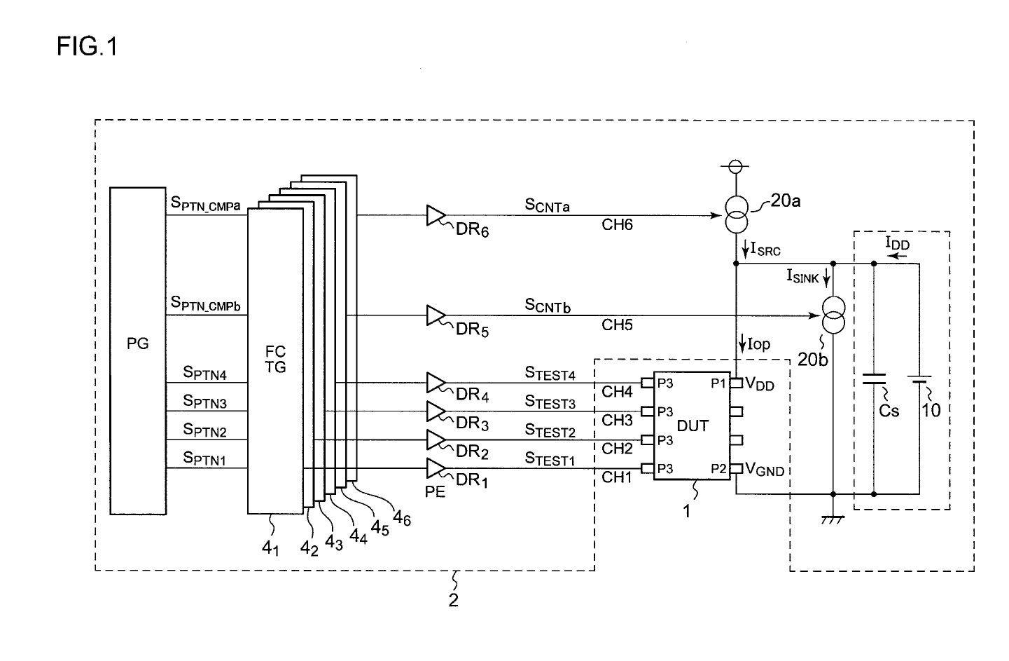

FIG. 1 is a circuit diagram which shows a configuration of a test apparatus 2 according to an embodiment. FIG. 1 shows a semiconductor device (which will be referred to as “DUT” hereafter) 1, in addition to the test apparatus 2.

The DUT 1 includes multiple pins. At least one of the multiple pins is a power supply terminal P1 configured to receive a power supply voltage V_{DD}, and at least one other pin is configured as a ground terminal P2. Multiple input/output (I/O) pins P3 are each configured to receive data from outside the circuit or to output data to outside the circuit. In the test operation, the multiple input/output terminals P3 receive a test signal (test pattern) S_{TEST} output from the test apparatus 2, or output data that corresponds to the test signal S_{TEST} to the test apparatus 2. FIG. 1 shows only a part of the configuration of the test apparatus 2, which is configured to supply a test signal to the DUT 1. That is to say, another configuration thereof configured to evaluate a signal received from the DUT 1 is not shown.

The test apparatus 2 includes a main power supply 10, a pattern generator PG, multiple timing generators TG, multiple waveform shapers FC, multiple drivers DR, and a power supply compensation circuit 20.

The test apparatus 2 includes multiple channels, e.g., n channels CH1 through CHn, several channels (CH1 through CH4) of which are respectively assigned to the multiple I/O terminals P3 of the DUT 1. FIG. 1 shows an arrangement in which n=6. However, in practical use, the number of channels of the test apparatus 2 is on the order of several hundred to several thousand.

The main power supply 10 generates the power supply voltage V_{DD} to be supplied to the power supply terminal P1 of the DUT 1. For example, the main power supply 10 is configured as a linear regulator, a switching regulator, or the like, and performs feedback control such that the power supply voltage V_{DD} to be supplied to the power supply terminal P1 matches a target value. The capacitor Cs is provided in order to smooth the power supply voltage V_{DD}. The main power supply 10 is configured to generate a power supply voltage to be supplied to the DUT 1. In addition, the main power supply 10 is further configured to generate a power supply voltage to be supplied to the other circuit blocks included in the test apparatus 2. The output current flowing from the main power supply 10 to the power supply terminal P1 of the DUT 1 will be referred to as the “power supply current I_{DD}”.

The main power supply 10 is configured as a voltage source or a current source having a limited response speed. Accordingly, in some cases, the main power supply 10 cannot follow a sudden change in the load current, i.e., the operating current I_{OP} of the DUT 1. For example, when the operating current I_{OP} changes in a stepwise manner, overshoot or undershoot occurs in the power supply voltage V_{DD}, following which, in some cases, ringing occurs in the power supply voltage V_{DD}. Such fluctuation in the power supply voltage V_{DD} leads to difficulty in testing the DUT 1 with high precision. This is why, when an error is detected in the operation of the DUT 1, such an arrangement cannot judge whether such an error is due a manufacturing fault in the DUT 1 or due to the fluctuation in the power supply voltage V_{DD}.

The power supply compensation circuit 20 is provided in order to compensate for the response speed of the main power supply 10. The designer of the DUT 1 can estimate the change over time in the operating rate of an internal circuit of the DUT 1 and so forth when a known test signal S_{TEST} (test pattern S_{PTN}) is supplied to the DUT 1. Accordingly, the designer can predict the waveform of the operating current I_{OP} of the DUT 1 over time with high precision. Examples of such a prediction method include a calculation method using computer simulation, or an actual measurement method in which a device having the same configuration as that of the DUT 1 is measured. Such a prediction method is not restricted in particular.

Furthermore, in a case in which the response speed of the main power supply 10 (gain, feedback band) is known, the designer can also estimate the power supply current I_{DD} generated by the main power supply 10 according to the estimated operating current I_{OP}. In this case, by compensating for the difference between the estimated operating current I_{OP} and the estimated power supply current I_{DD} by means of the power supply compensation circuit 20, such an arrangement is capable of stabilizing the power supply voltage V_{DD}.

It should be noted that a differential relation or an integral relation holds true between the power supply voltage V_{DD}′ and the power supply current I_{DD}. Specifically, which relation of either a differential relation or an integral relation holds true is determined depending on which component is dominant with respect to the impedance of the main power supply 10 itself and the impedance of a path from the main power supply 10 up to the power supply terminal P1 among the capacitance component, inductance component, or resistance component.

The power supply compensation circuit 20 includes a source compensation circuit 20a and a sink compensation circuit 20b. The source compensation circuit 20a is configured to be switchable between an on state and an off state according to a control signal S_{CNTa}. When the source compensation circuit 20a is turned on according to the control signal S_{CNTa}, a compensation pulse current (which will also be referred to as the “source pulse current”) I_{SRC} is generated. The power supply compensation circuit 20 is configured to inject the source pulse current I_{SRC} into the power supply terminal P1 via a path that differs from that of the main power supply 10.

Similarly, the sink compensation circuit 20b is configured to be switchable between an on state and an off state according to a control signal S_{CNTb}. When the sink compensation circuit 20b is turned on according to the control signal S_{CNTb}, a compensation pulse current (which will also be referred to as the “sink pulse current”) I_{SINK} is generated. The power supply compensation circuit 20 is configured to draw, via a path that differs from that of the DUT 1, the sink pulse signal I_{SINK} from the power supply current I_{DD} that flows to the power supply terminal P1.

The following Expressions (1) and (2) hold true between the operating current I_{OP} that flows to the power supply terminal P1 of the DUT 1 and the compensation current I_{CMP} output from the power supply compensation circuit 20, based upon the current conservation law.

I_{OP}=I_{DD}+I_{CMP} (1)

I_{CMP}=I_{SRC}−I_{SINK} (2)

That is to say, the positive component of the compensation current I_{CMP} is supplied from the source compensation circuit 20a as the source pulse current I_{SRC}. The negative component of the compensation current I_{CMP} is supplied from the sink compensation circuit 20b as the sink pulse current I_{SINK}.

Among the drivers DR₁ through DR₆, the driver DR₆ is assigned to the source compensation circuit 20a, and the driver DR₅ is assigned to the sink compensation circuit 20b. At least one of the other drivers, e.g., the drivers DR₁ through DR₄, are respectively assigned to at least one of the I/O terminals P3 of the DUT 1. The pattern generator PG, the drivers DR₅ and DR₆, and the interface circuits 4₅ and 4₆, can be regarded as a control circuit configured to control the power supply compensation circuit 20.

A pair comprising the waveform shaper FC and the timing generator TG is collectively referred to as an “interface circuit 4”. Multiple interface circuits 4₁ through 4₆ are respectively provided for the channels CH1 through CH6, i.e., for the drivers DR₁ through DR₆. The i-th (1≦i≦6) interface circuit 4ᵢ shapes the input pattern signal S_{PTNi} such that it has a signal format that is suitable for the driver DR, and outputs the pattern signal thus shaped to the corresponding driver DRᵢ.

The pattern generator PG generates the pattern signals S_{PTN} for the interface circuits 41 through 4₆ according to a test program. Specifically, with regard to the drivers DR₁ through DR₄ respectively assigned to the I/O terminals P3 of the DUT 1, the pattern generator PG outputs the test patterns S_{PTNi}, each specifying a test signal S_{TESTi} to be generated by the corresponding driver DRᵢ, to the respective interface circuits 4ᵢ that correspond to the respective drivers DRᵢ. Each test pattern S_{PTNi} includes data which represents the signal level for each cycle (unit interval) of the test signal S_{TESTi}, and data which indicates the timing at which the signal level transits.

Furthermore, the pattern generator PG generates compensation control patterns S_{PTN}_{_{—}}_{CMP} determined according to the required compensation current I_{CMP}. The control patterns S_{PTN}_{_{—}}_{CMP} are composed of a control pattern S_{PTN}_{_{—}}_{CMPa} which specifies the control signal S_{CNTa} to be generated by the driver DR₆ assigned to the source compensation circuit 20a, and a control pattern S_{PTN}_{_{—}}_{CMPb} which specifies the control signal S_{CNTb} to be generated by the driver DR₅ assigned to the sink compensation circuit 20b. The control patterns S_{PTN}_{_{—}}_{CMPa} and S_{PTN}_{_{—}}_{CMPb} respectively include data which specifies the on/off state of the source compensation circuit 20a for each cycle, and data which specifies the on/off state of the sink compensation circuit 20b for each cycle. Furthermore, the control patterns S_{PTN}_{_{—}}_{CMPa} and S_{PTN}_{_{—}}_{CMPb} respectively include data which specifies the timing at which the on/off state of the source compensation circuit 20a is to be switched, and data which specifies the timing at which the on/off state of the sink compensation circuit 20b is to be switched.

The pattern generator PG generates the control patterns S_{PTN}_{_{—}}_{CMPa} and S_{PTN}_{_{—}}_{CMPb} so as to allow fluctuation in the operating current of the DUT 1 to be compensated for, according to the test patterns S_{PTN1} through S_{PTN4}, i.e., according to the fluctuation in the operating current of the DUT 1. The pattern generator PG outputs these control patterns S_{PTN}_{_{—}}_{CMPa} and S_{PTN}_{_{—}}_{CMPb} to the corresponding interface circuits 4₆ and 4₅, respectively.

As described above, if the test patterns S_{PTN1} through S_{PTN4} are known, the waveform over time of the operating current I_{OP} of the DUT 1 can be estimated. Thus, the waveforms over time of the compensation current I_{CMP}, i.e., the waveforms over time of I_{SRC} and I_{SINK}, which are to be generated in order to maintain the power supply voltage V_{DD} at a constant level, can be calculated.

When the estimated operating current I_{OP} is greater than the power supply current I_{DD}, the power supply compensation circuit 20 generates a source compensation current I_{SRC} so as to compensate for a shortfall in the current. The current waveform that is required to generate such a source compensation current I_{SRC} can be predicted. Thus, the source compensation circuit 20a is controlled so as to appropriately generate the source compensation current I_{SRC}. For example, the source compensation circuit 20a may be controlled by pulse width modulation. Alternatively, pulse amplitude modulation, delta-sigma modulation, pulse density modulation, pulse frequency modulation, or the like, may be employed.

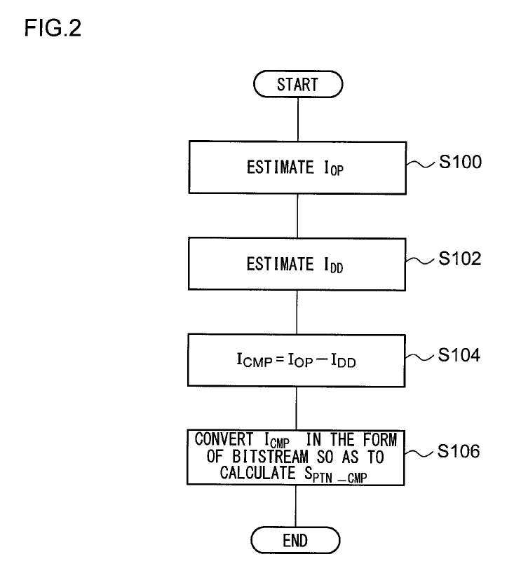

FIG. 2 is a flowchart which shows an example of a method for calculating the control pattern. The operating current I_{OP} of the DUT 1 is estimated based upon the test pattern input to the DUT 1 and the circuit information (S100). When such an event occurs in the DUT 1 in a state in which the DUT 1 is connected as a load to the main power supply 10, the power supply current I_{DD} output from the main power supply 10 is calculated (S102). In a case in which the user desires to provide an ideal power supply, the difference between the operating current I_{OP} thus estimated and the power supply current I_{DD} thus estimated is set as the compensation current I_{CMP} to be generated by the power supply compensation circuit (S104).

Subsequently, the waveform of the compensation current I_{CMP} to be generated is subjected to delta-sigma modulation, PWM (pulse width modulation), PDM (pulse density modulation), PAM (pulse amplitude modulation), PFM (pulse frequency modulation), or the like, so as to generate a control pattern S_{PTN}_{_{—}}_{CMP} in the form of a bitstream (S106). For example, sampling of the compensation current I_{CMP} may be performed for each test cycle, and the sampled compensation current I_{CMP} may be subjected to pulse modulation.

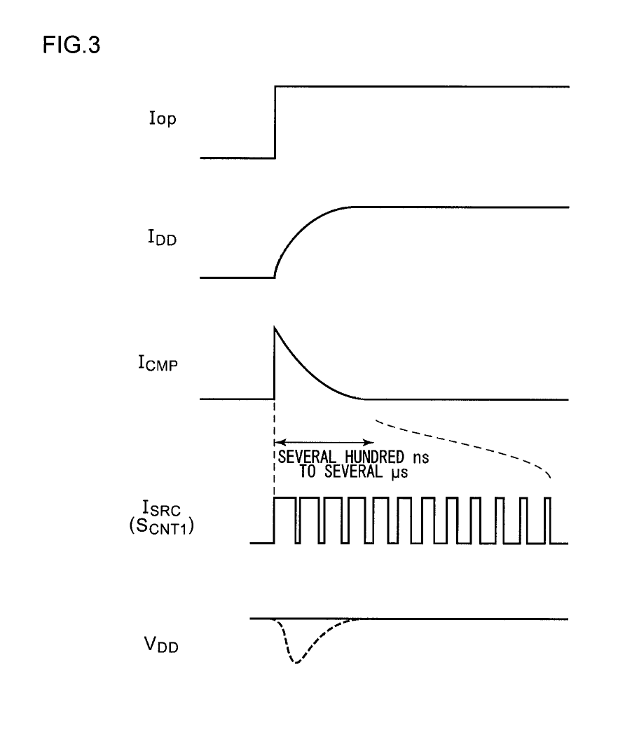

FIG. 3 is a waveform diagram which shows an example of the operating current I_{OP}, the power supply current I_{DD}, the source compensation current I_{CMP}, and the source pulse current I_{SRC}. Let us say that, when a certain test signal S_{TEST} is supplied to the DUT 1, the operating current I_{OP} of the DUT 1 rises in a stepwise manner. In response to the increase in the operating current I_{OP}, the power supply current I_{DD} is supplied from the main power supply 10. However, such a power supply current I_{DD} does not have an ideal step waveform because of the limited response speed. This leads to a shortfall in the current to be supplied to the DUT 1. As a result, if the compensation current I_{SRC} is not supplied, the power supply voltage V_{DD} falls as indicated by the broken line.

The power supply compensation circuit 20 generates the source compensation current I_{CMP} that corresponds to the difference between the operating current I_{OP} and the power supply current I_{DD}. The source compensation current I_{CMP} is provided as the source pulse current I_{SRC} generated according to the control signal S_{CNTa}. The source compensation current I_{CMP} is required to be at its maximum value immediately after the change in the operating current I_{OP}, and is required to gradually fall from its maximum value. Accordingly, the on time (duty ratio) of the source compensation circuit 20a is reduced over time using PWM (pulse width modulation), for example, thereby generating the required source compensation current I_{CMP}.

In a case in which all the channels of the test apparatus 2 operate in synchronization with a test rate, the period of the control signal S_{CNTa} matches the period (unit interval) of data to be supplied to the DUT 1, or a period obtained by multiplying or dividing the period of the data by an integer. For example, in a case in which the period of the control signal S_{CNTa} is set to 4 ns in a system in which the unit interval is 4 ns, the on period TON of each pulse included in the control signal S_{CNTa} can be adjusted in a range between 0 and 4 ns. The response speed of the main power supply 10 is on the order of several hundred ns to several μs. Thus, the waveform of the compensation current I_{CMP} can be controlled by adjusting several hundred of the pulses included in the control signal S_{CNTa}. A method for deriving the control signal S_{CNTa} required to generate the source compensation current I_{SRC} based upon the waveform thereof will be described later.

Conversely, when the operating current I_{OP} is smaller than the power supply current I_{DD}, the power supply compensation circuit 20 generates a sink pulse current I_{SINK} so as to provide the sink compensation current I_{CMP}, thereby drawing the excess current.

By providing such a power supply compensation circuit 20, such an arrangement is capable of compensating for a shortfall in the response speed of the main power supply 10, thereby maintaining the power supply voltage V_{DD} at a constant level as indicated by the solid line in FIG. 3. Furthermore, as described above, the power supply compensation circuit 20 is capable of generating a pulse current having a stabilized amplitude, thereby compensating for the power supply voltage with high precision.

The above is the overall configuration of the test apparatus 2.

Next, description will be made regarding a specific example configuration of the power supply compensation circuit 20.

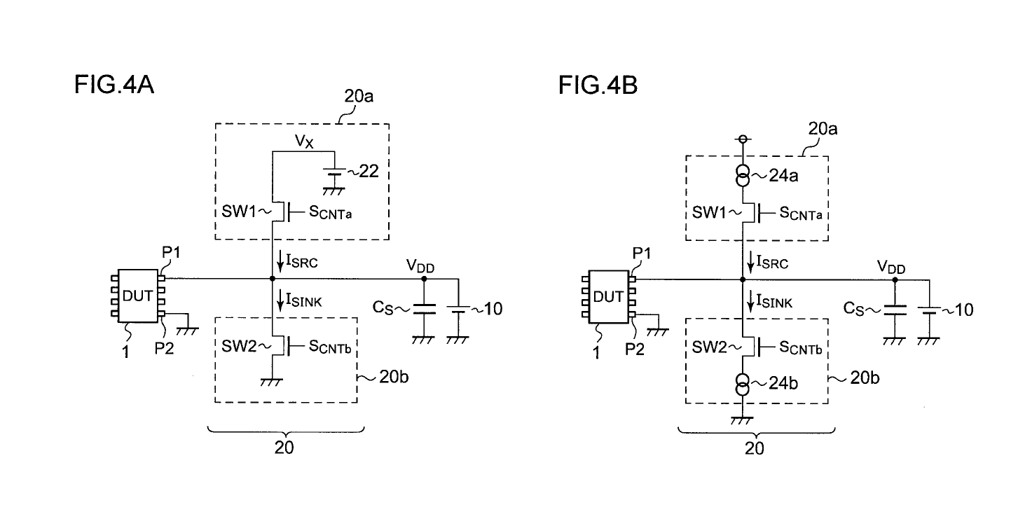

FIGS. 4A and 4B are circuit diagrams each showing an example configuration of the power supply compensation circuit 20.

Referring to FIG. 4A, the source compensation circuit 20a includes a voltage source 22 configured to generate a voltage Vx that is higher than the power supply voltage V_{DD}, and a source switch SW1. The source switch SW1 is arranged between the output terminal of the voltage source 22 and the power supply terminal P1.

If the voltage Vx and the power supply voltage V_{DD} are each maintained at a constant voltage level, when the source switch SW1 is in the on state, the amplitude of the source current I_{SRC} is represented by I_{SRC}=(Vx−V_{DD})/R_{ON1}. R_{ON1} represents the on resistance of the source switch SW1. Such arrangements shown in FIGS. 4A and 4B each have an advantage of a reduced circuit configuration of the power supply compensation circuit 20.

The sink compensation circuit 20b includes a sink switch SW2 arranged between the power supply terminal P1 and the ground terminal. When the power supply voltage V_{DD} is maintained at a constant voltage level in a state in which the sink switch SW2 is turned on, the amplitude of the sink current I_{SINK} is represented by I_{SINK}=V_{DD}/R_{ON2}. Here, R_{ON2} represents the on resistance of the sink switch SW2.

Returning to FIG. 4B, the source compensation circuit 20a includes a source current source 24a and a source switch SW1. The source current source 24a is configured to generate a reference current which determines the amplitude of the source pulse current I_{SRC}. The source switch SW1 is arranged on a path of the reference current supplied from the source current source 24a.

The sink compensation circuit 20b includes a sink switch SW2 and a sink current source 24b. The sink current source 24b is configured to generate a reference current which determines the amplitude of the sink pulse current K_{SINK}. The sink switch SW2 is arranged on a path of the reference current supplied from the sink current source 24b.

In some cases, the amplitudes of the source pulse current I_{SRC} and the sink pulse current I_{SINK} are each required to be on the order of several A. With such an arrangement, the sizes of the source switch SW1 and the sink switch SW2 shown in FIGS. 4A and 4B each become large, leading to an increase in their gate capacity. Such an increase in the gate capacity of both the source switch SW1 and the sink switch SW2 leads to each of the source switch SW1 and the sink switch SW2 having a reduced response speed. This leads to the potential to fail to generate a desired current.

Furthermore, if there are irregularities in the on resistance R_{ON1} of the source switch SW1 or in the on resistance R_{ON2} of the sink switch SW2, or if the amplitude of the control signal S_{CNTa} or the amplitude of the control signal S_{CNTb} fluctuates, the degree of the on state of each switch fluctuates. In some cases, this leads to fluctuation in the amplitude of the pulse current I_{SRC} or I_{SINK}.

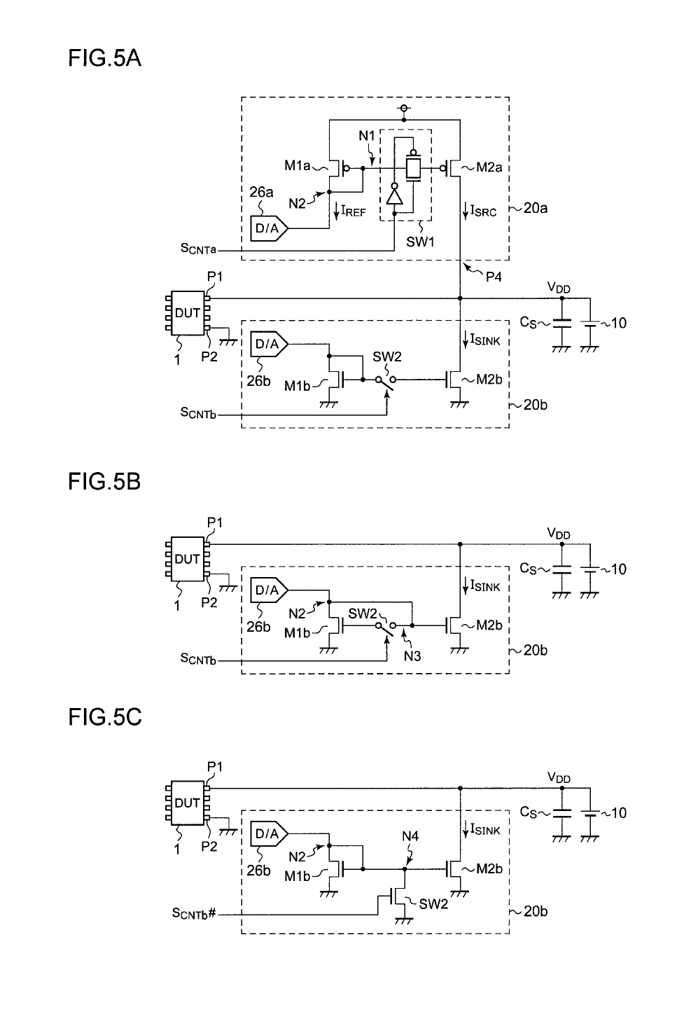

In a case in which such a problem becomes conspicuous, the following technique may be employed in order to solve such a problem. FIGS. 5A through 5C are circuit diagrams each showing a different example configuration of the power supply compensation circuit 20.

A source compensation circuit 20a shown in FIG. 5A includes a current D/A converter 26a, a first transistor M1a, a second transistor M2a, and a source switch SW1.

The current D/A converter 26a is configured to generate a reference current I_{REF} that corresponds to a digital setting signal D_{SET}. The first transistor M1a and the second transistor M2a form a current mirror circuit, which is configured to generate a sink pulse current I_{SINK} obtained by multiplying the reference current I_{REF} by a predetermined coefficient (mirror ratio K).

Specifically, the first transistor M1a is configured as a P-channel MOSFET, and is arranged on a path of the reference current I_{REF}. The second transistor M2 is also configured as a P-channel MOSFET, and is arranged such that the gate thereof is connected to the gate and the drain of the first transistor M1a.

In FIG. 5A, the source switch SW1 is arranged between the gate of the first transistor M1a and the gate of the second transistor M2a. For example, the source switch SW1 is configured as a transfer gate as shown in FIG. 5A. Alternatively, the source switch SW1 may be configured employing only N-channel MOSFETs or only P-channel MOSFETs. The on/off state of the source switch SW1 is switched according to a control signal S_{CNTa}.

In FIG. 5A, the drain N2 of the first transistor M1a is connected to the terminal N1 of the source switch SW1 on the side of the gate of the first transistor M1a.

During the period in which the control signal S_{CNTa} is high level, the source switch SW1 is turned on. In this state, the source pulse current I_{SRC} that is proportional to the reference current I_{REF} is discharged from the output terminal P4 of the source compensation circuit 20a. During a period in which the control signal S_{CNTa} is low level, the source switch SW1 is turned off. In this state, the current mirror circuit does not operate, which sets the source pulse current I_{SRC} to zero.

As described above, the source compensation circuit 20a shown in FIG. 5A is capable of generating the source pulse current I_{SRC} that is switched on and off according to the control signal S_{CNTa}.

With such a source compensation circuit 20a shown in FIG. 5A, such an arrangement provides improvement in the stability of the amplitude of the source pulse current I_{SRC}. Furthermore, the target to be driven by the driver DR is not a switch via which a large amount of current would flow. Instead, the target to be driven by the driver DR is a switch arranged at the gate of the current mirror circuit. Thus, such an arrangement enables high-speed switching.

Furthermore, with the source compensation circuit 20a shown in FIG. 5A, the reference current I_{REF} continuously flows through the first transistor M1a even if the source switch SW1 is set to the off state, thereby maintaining the bias state of the first transistor M1a. Thus, such an arrangement has an advantage of a high response speed in the switching of the source compensation circuit 20a with respect to the switching of the source switch SW1.

The sink compensation circuit 20b can be configured by reversing the conductivity type of each transistor, and by inverting the configuration of the source compensation circuit 20a. FIG. 5A shows an example configuration of the sink compensation circuit 20b. The sink compensation circuit 20b includes a current D/A converter 26b, transistors M1b and M2b which are each configured as an N-channel MOSFET, and a sink switch SW2. The sink compensation circuit 20b has the advantages as those of the source compensation circuit 20a.

FIGS. 5B and 5C each show only a configuration of the sink compensation circuit 20b, and the source compensation circuit 20a is not shown in these drawings.

FIG. 5B shows an arrangement in which the sink switch SW2 is arranged at a position that differs from that shown in FIG. 5A. In FIG. 5B, the drain N2 of the first transistor M1b is connected to the terminal N3 of the sink switch SW2 on the side of the gate of the second transistor M2b.

Such an arrangement is also capable of generating a sink pulse current I_{SINK} having a stabilized amplitude and that can be switched at a high speed, as with the configuration shown in FIG. 5A.

Furthermore, with such an arrangement shown in FIG. 5B, when the sink switch SW2 is turned off, the reference current I _{REF} is cut off. Thus, such an arrangement has an advantage of a reduction in the current consumption of the circuit.

In FIG. 5C, the sink switch SW2 is arranged between a gate N4, obtained by connecting the gates of the first transistor M1b and the second transistor M2b so as to form a common gate terminal, and a fixed voltage terminal such as a ground terminal. When the sink switch SW2 is turned on, i.e., during a period in which a control signal S_{CNTb}# (“#” represents logical inversion) is high level, the gate voltage of each of the first transistor M1 and the second transistor M2 is set to the ground voltage. In this state, the current mirror circuit is turned off, and accordingly, the sink pulse current I_{SINK} is cut off. When the sink switch SW2 is turned off, i.e., during a period in which the control signal S_{CNTb}# is low level, the current mirror circuit is turned on. In this state, the sink pulse current I_{SINK} flows.

Such an arrangement shown in FIG. 5C is capable of generating a sink pulse current I_{SINK} having a stabilized amplitude and that can be switched at a high speed, as with the aforementioned arrangements shown in FIGS. 5A and 5B. It is needless to say that such modifications shown in FIGS. 5B and 5C can be applied to the source compensation circuit 20a.

Also, such an arrangement shown in FIG. 5C may be combined with the arrangement shown in FIG. 5A or the arrangement shown in FIG. 5B.

The current that flows through the internal components that form the DUT 1, i.e., the operating current I_{OP} changes due to process variations. That is to say, when a given test pattern is supplied to the DUT 1, there are irregularities in the waveform of the operating current of the DUT 1 due to process variations. In order to solve such a problem, before the test step for the DUT 1, a calibration step may be performed in which the amplitude of the compensation pulse current is adjusted. Such an arrangement is capable of maintaining the power supply environment at a constant level even if there are irregularities in the operating current I_{OP} of the DUT 1 due to process variations. Such calibration can be performed by adjusting the digital setting value D_{SET} for the current D/A converters 26a and 26b.

The above is an example configuration of the power supply compensation circuit 20.

Description has been made above regarding an arrangement which requires that the operating current I_{OP} of the DUT 1 is predictable based upon the test pattern. However, a highly functional IC (Integrated Circuit) such as an SoC (System On Chip) or the like has the potential to have an operating state that fluctuates independent of the test pattern. In particular, devices that will be developed in the future could operate autonomously or could perform an operation which cannot be predicted by an external circuit, as compared with conventional devices. In order to solve such a problem, description will be made below regarding a test apparatus which is capable of stabilizing the power supply voltage V_{DD} when testing such a DUT 1.

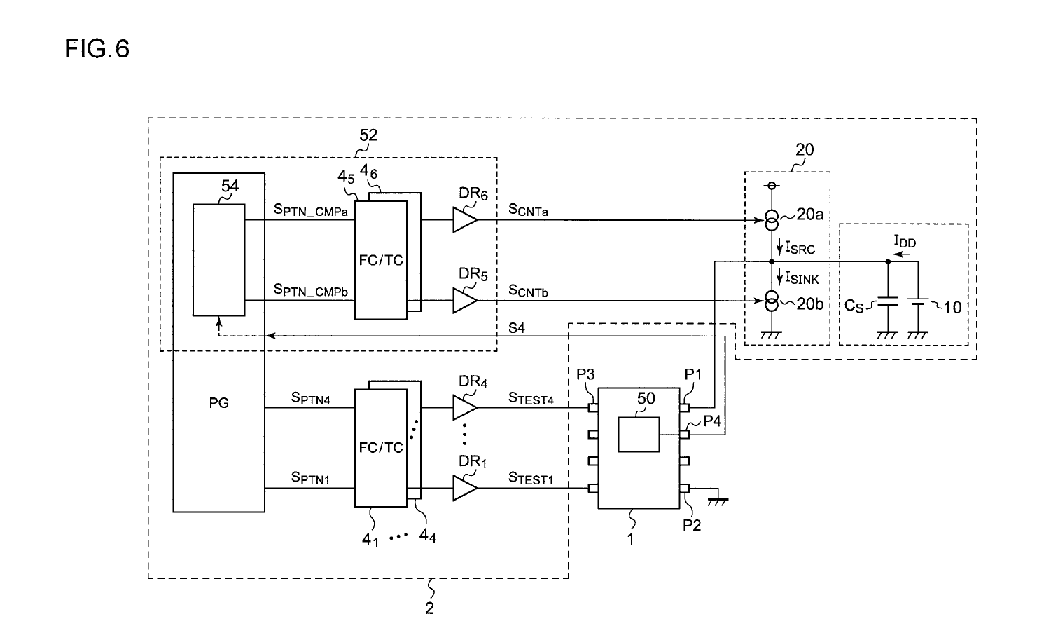

FIG. 6 is a block diagram which shows a configuration of a test apparatus 2 according to an embodiment. A DUT 1 includes a notifying circuit 50 as a built-in component configured to issue a notification signal S4. Before the occurrence of an event (which will also be referred to as a “significant event”) which is the cause of a change in the operating current I_{OP} of the DUT 1, the notifying circuit 50 outputs, via a terminal P4, a notification signal S4 which is used to notify an external circuit of the occurrence of such an event. The notification signal S4 may include data which indicates the information associated with the event. The notifying circuit 50 may be a circuit configured based upon the so-called DFT (Design For Test) thinking. Also, a circuit mounted for a primary purpose that differs from the testing of the DUT may also be used to detect such an event when testing the DUT.

Description will be made below regarding examples of the DUT 1 and the significant event.

1. The DUT 1 may be configured as a multi-core processor. Such a DUT 1 autonomously changes the number of active cores. With such a DUT 1, the number of active cores changes autonomously according to the amount of computation, and the operating current I_{OP} of the DUT 1 changes according to the number of active cores. That is to say, the number of active cores can be used as a significant event. In this case, the notification signal S4 may include data which indicates the number of active cores after switching of the active core.

2. The DUT 1 may be configured to operate at a variable operating frequency, and may be configured to autonomously switch its operating frequency. The operating current I_{OP} of such a DUT 1 has the potential to change according to the operating frequency f. Thus, the switching of the operating frequency f can be used as the significant event. In this case, the notification signal S4 may include data which indicates the operating frequencies f before and after the switching of the operating frequency.

3. The DOT 1 may include a clock gating circuit and/or a power gating circuit, which is used to reduce power consumption. With such an arrangement, the current consumption has the potential to greatly change at a timing at which the clock gating circuit or the power gating circuit starts to operate, or a timing at which the clock gating circuit or the power gating circuit stops to operate. That is to say, the on/off switching of the clock gating circuit or the power gating circuit can be used as the significant event.

4. For example, the DUT 1 may be configured as an SoC (System on Chip) device including an analog circuit device or an analog circuit. Examples of the significant events that occur in an analog circuit include the switching of settings of the analog circuit, the switching of the operating mode of the analog circuit, etc.

A test apparatus 2 includes a compensation control circuit 52. The compensation control circuit 52 receives the notification signal S4 from the DUT 1, and generates control signals S_{CNTa} and S_{CNTb}, which are to be used to control respective switch elements (SW1 and SW2) of a power supply compensation circuit 20. The control signals S_{CNTa} and S_{CNTb} are generated based upon at least the notification signal S4. It is needless to say that the operating current I_{OP} may depend on the test pattern S_{PTN}. In this case, the compensation control circuit 52 generates the control signals S_{CNTa} and S_{CNTb} according to the test pattern S_{PTN}, in addition to according to the notification signal S4.

The compensation control circuit 52 may be configured including an interface circuit 4₅ and a driver DR₅, and an interface circuit 4₆ and a driver DR₆, which are respectively assigned to the source switch SW1 and the sink switch SW2, and a part of a pattern generator PG (which will also be referred to as the “control pattern generating unit 54”).

Based upon the notification signal S4, the control pattern generating unit 54 detects a significant event that will occur in the DUT 1 in the next step. By means of simulation or other methods such as actual measurement, the designer of the DUT 1 (i.e., the user of the test apparatus 2) can estimate beforehand the change in the operating current I_{OP} that occurs in the DUT 1 due to each significant event. Furthermore, the designer can calculate a compensation current I_{CMP} required to cancel out the change in the operating current I_{OP}. The control pattern generating unit 54 is configured to be capable of generating the control patterns S_{PTN}_{_{—}}_{CMPa} and S_{PTN}_{_{—}}_{CMPb} that allow the change in the operating current I_{OP} that occurs as a consequence of the significant event that occurs in the DUT 1 to be canceled out. For example, the control pattern generating unit 54 may include pattern memory configured to hold the control patterns S_{PTN}_{_{—}}_{CMPa} and S_{PTN}_{_{—}}_{CMPb}, and may read out the control pattern every time the significant event occurs. Alternatively, other methods may be used to generate such a control pattern.

When the control pattern generating unit 54 generates the control patterns S_{PTN}_{_{—}}_{CMPa} and S_{PTN}_{_{—}}_{CMPb}, the corresponding control signals S_{CNTa} and S_{CNTb} are supplied to the power supply compensation circuit 20, and the power supply compensation circuit 20 generates the compensation current I_{CMP} used to suppress fluctuation in the operating current I_{OP}.

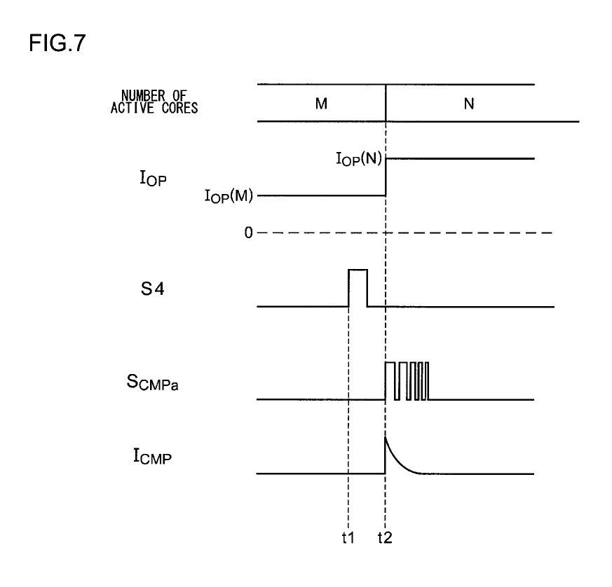

The above is the configuration of the test apparatus 2. Next, description will be made regarding the operation thereof. FIG. 7 is a time chart which shows the operation of the test apparatus 2 shown in FIG. 6. In this description, let us consider an arrangement in which the DUT 1 is configured as a multi-core processor, and the switching of the number of active cores is used as the significant event.

In the initial state, the number of the active cores is M, and the amount of current that flows through the DUT 1 is represented by I_{OP}(M). At the time point t2, the DUT autonomously switches the number of active cores to N, which changes the operating current I_{OP}. At the time point t1 before the time point t2, the DUT 1 issues the notification signal S4 so as to notify the test apparatus 2 of the switching of the number of active cores. Furthermore, the notification signal S4 may include timing data D3 which indicates the timing t2 at which the number of active cores is switched in the DUT 1 in actuality. The timing data D3 may be configured as data which indicates the wait time (delay time) which elapses from the timing t1 at which the notification signal S4 is issued up to the timing t2 at which the active cores are switched.

Upon receiving the notification signal S4, at an appropriate timing, the compensation control circuit 52 generates the control signal S_{CMPa} that corresponds to the significant event indicated by the notification signal S4. Thus, such an arrangement is capable of suppressing fluctuation in the power supply voltage V_{DD} due to the change in the operating current I_{CMP} that occurs at the time point t2.

The amount of the compensation current I_{CMP} to be generated depends on the difference between the operating current I_{OP}(M) that flows before the time point t2 and the operating current I_{OP}(N) that flows after the time point t2. In some cases, the operating currents I_{OP}(M) and I_{OP}(N) depend on the number of active cores M and N, respectively. In this case, there is a need to generate the compensation currents I_{CMP} according to the number of active cores M and N. In order to satisfy such a requirement, the notification signal S4 generated by the DUT 1 may include additional data D2 which indicates the number M of active cores before the active core switching and the number N of active cores after the active core switching, in addition to data D1 which indicates that the number of active cores has been switched. Thus, such an arrangement allows the compensation control circuit 52 to generate a suitable amount of the compensation current I_{CMP}. As described above, the notification signal S4 may include such additional data that is required to predict the change in the operating current I_{OP} of the DUT 1.

As described above, with the test apparatus 2 according to an embodiment, the waveform of the operating current of the DUT 1 is predicted based upon the notification signal S4, and the power supply compensation circuit 20 is instructed to generate the compensation current I_{CMP} that corresponds to the operating current waveform thus predicted. Thus, such an arrangement is capable of suppressing fluctuation in the power supply voltage V_{DD} even if the DUT 1 performs an autonomous operation that is independent of the test pattern.

Description has been made regarding the present invention with reference to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such a modification.

In addition to the DUT 1 configured to perform an autonomous operation and the significant events used in such a DUT 1 described in the aforementioned embodiments, other arrangements may be made with respect to the DUT 1 and the significant event, which will be described below. Such a DUT 1 is also encompassed within the scope of the present invention.

For example, the DUT 1 may include a PLL (Phase Locked Loop) circuit. In some cases, such a DUT 1 performs a particular operation after the PLL circuit is locked, depending on the kind of DUT. Thus, an event in which the PLL circuit is locked may be used as the significant event.

Also, the DUT 1 may include flash memory. Such flash memory is set to the busy state during a period from the time point at which an instruction to write (or erase) data is received until the time point at which the data writing is completed. Here, the timing at which the data writing is completed is independent of the test pattern. That is to say, the operating current I_{OP} has the potential to decrease at a timing at which data writing is completed. Thus, the data writing completion or the data erasing completion can be used as the significant event. Conventional flash memory generates a flag signal (R/B signal) which indicates the ready/busy state after the data writing is completed. Accordingly, an arrangement configured to generate a control signal according to the R/B signal cannot provide a sufficient response speed. In order to solve such a problem, the DUT 1 may be configured to generate the R/B signal immediately before the timing at which the data writing is completed. Such an arrangement allows the compensation current to be generated at a suitable timing.

Description has been made in the embodiment regarding an arrangement configured to provide an ideal power supply environment having no fluctuation in the power supply voltage, i.e., having zero output impedance, using the compensation current I_{CMP}. However, the present invention is not restricted to such an arrangement. That is to say, the waveform of the compensation current I_{CMP} may be calculated so as to provided an intentional change in the power supply voltage, and the control pattern S_{PTN}_{_{—}}_{CMP} may be determined so as to provide such a compensation current waveform. Such an arrangement is capable of emulating a power supply environment as desired according to the control pattern S_{PTN}_{_{—}}_{CMP}.

Description has been made in the embodiment regarding an arrangement in which the power supply compensation circuit 20 includes the source compensation circuit 20a and the sink compensation circuit 20b. However, the present invention is not restricted to such an arrangement. Also, the power supply compensation circuit 20 may be configured including only one of either the source compensation circuit 20a or the sink compensation circuit 20b.

In a case in which the power supply compensation circuit 20 includes only the source compensation circuit 20a, such an arrangement may instruct the source compensation circuit 20a to generate a constant current I_{DC}. With such an arrangement, when a shortfall occurs in the power supply current I_{DD} with respect to the operating current I_{OP}, the current I_{SRC} generated by the source compensation circuit 20a may be increased relative to the constant current I_{DC}. Conversely, when the power supply current I_{DD} is excessive with respect to the operating current I_{OP}, the current I_{SRC} generated by the source compensation circuit 20a may be reduced relative to the constant current I_{DC}.

In a case in which the power supply compensation circuit 20 includes only the sink compensation circuit 20b, such an arrangement may instruct the sink compensation circuit 20b to generate a constant current I_{DC}. With such an arrangement, when a shortfall occurs in the power supply current I_{DD} with respect to the operating current I_{OP}, the current I_{SINK} generated by the sink compensation circuit 20b may be reduced relative to the constant current I_{DC}. Conversely, when the power supply current I_{DD} is excessive with respect to the operating current I_{OP}, the current I_{SINK} generated by the sink compensation circuit 20b may be increased relative to the constant current I_{DC}.

Such an arrangement has a disadvantage of increased current consumption in the overall operation of the test apparatus by the constant current ‘_{DC} thus generated. However, such an arrangement has an advantage in that it requires only a single switch to generate the compensation currents I_{SRC} and I_{SINK}.

While the preferred embodiments of the present invention have been described using specific terms, such description is for illustrative purposes only, and it is to be understood that changes and variations may be made without departing from the spirit or scope of the appended claims.

What is claimed is:

1. A test apparatus configured to test a device under test, wherein the device under test comprises a notifying circuit configured to generate a notification signal that is used to notify an external circuit of an event, which leads to a change in an operating current of the device under test, before the event occurs,
and wherein the test apparatus comprises:
a main power supply configured to supply electric power to a power supply terminal of the device under test;
a power supply compensation circuit comprising at least one of a source compensation circuit that comprises a switch element controlled according to a control signal, and which is configured to generate a compensation pulse current according to an on/off state of the switch element, and to inject the compensation pulse current to the power supply terminal via a path that differs from that of the main power supply, and a sink compensation circuit that comprises a switch element controlled according to a control signal, and which is configured to generate a compensation pulse current according to an on/off state of the switch element, and to draw, via a path that differs from that of the device under test, the compensation pulse current from a power supply current that flows from the main power supply to the device under test; and
a compensation control circuit configured to receive the notification signal from the device under test, and to output, to the switch element, the control signal which is used to control the switch element, and which is generated based upon at least the notification signal.

2. A test apparatus according to claim 1, wherein the device under test comprises a plurality of cores,
and wherein the notification signal notifies an event in which the number of active cores is switched.

3. A test apparatus according to claim 1, wherein the device under test is configured to be capable of changing its operating frequency,
and wherein the notification signal notifies an event in which the operating frequency of the device under test is switched.

4. A test apparatus according to claim 1, wherein the device under test comprises a clock gating circuit,
and wherein the notification signal notifies an event in which an on/off operation of the clock gating circuit is switched.

5. A test apparatus according to claim 1, wherein the device under test comprises a power gating circuit,
and wherein the notification signal notifies an event in which an on/off operation of the power gating circuit is switched.

6. A test apparatus according to claim 1, wherein the device under test is configured as an SoC (System On Chip) comprising an analog circuit device or an analog circuit,
and wherein the notification signal notifies an event in which an operation mode of the analog circuit is switched.

7. A test apparatus according to claim 1, wherein the device under test is configured as an SoC (System On Chip) comprising an analog circuit device or an analog circuit,
and wherein the notification signal notifies an event in which settings of the analog circuit is switched.
